(19) United States
(12) Patent Application Publication
(10) Pub. No.: US 2023/0385607 A1
(43) Pub. Date: Nov. 30, 2023

(54) HYPERGRAPH-BASED COLLABORATIVE FILTERING RECOMMENDATIONS

(71) Applicant: SONY GROUP CORPORATION, TOKYO (JP)

(72) Inventors: PROSENJIT BISWAS, BENGALURU (IN); BRIJRAJ SINGH, BENGALURU (IN); RAKSHA JALAN, BENGALURU (IN)

(21) Appl. No.: 18/319,096

(22) Filed: May 17, 2023

Related U.S. Application Data
(60) Provisional application No. 63/365,540, filed on May 31, 2022.

(51) Int. Cl. G06N 3/045

(52) U.S. Cl. CPC G06N 3/045

(57) ABSTRACT

An electronic device and a method for implementation of hypergraph-based collaborative filtering recommendations. The electronic device receives a collaborative filtering graph corresponding to a set of users and a set of items. The electronic device determines a first set of user embeddings and a first set of item embeddings. The electronic device applies a semantic clustering model to determine a second set of user embeddings and a second set of item embeddings. The electronic device constructs a hypergraph to determine a third set of user embeddings and a third set of item embeddings. The electronic device determines a first contrastive loss and a second contrastive loss to determine a collaborative filtering score. The electronic device determines a recommendation of an item for a user based on the determined collaborative filtering score. The electronic device renders the determined recommended item on a display device.

### CROSS-REFERENCE TO RELATED APPLICATIONS/INCORPORATION BY REFERENCE

This application also makes reference to U.S. Provisional Application Ser. No. 63/365,540, which was filed on May 31, 2022. The above stated patent applications are hereby incorporated herein by reference in their entirety.

### FIELD

Various embodiments of the disclosure relate to recommendation systems. More specifically, various embodiments of the disclosure relate to an electronic device and a method for hypergraph-based collaborative filtering recommendations.

### BACKGROUND

Advancements in the field of recommendation systems have led to development of different types of recommendation models that have capability to provide personalized recommendations to users. The recommendation systems may be used in diverse fields such as, media and entertainment, finance, e-commerce, retail, banking, telecom, and so on. Typically, a recommendation system may recommend an item (for example, a movie) associated with a domain (for example, movies domain for an over-the-top platform), to a user, based on parameters such as personal particulars/profile of the user, a watch history of the user, a movie consumption pattern (for example, an amount of time spent to watch each movie), a genre of movies in the watch history, and so on. Conventional recommendation system may ignore higher-order relationships between users and items. Thus, the conventional recommendation systems may be sub-optimal and may often make inaccurate recommendations.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for hypergraph-based collaborative filtering recommendations is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for hypergraph-based collaborative filtering recommendations, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary scenario of a collaborative filtering graph, in accordance with an embodiment of the disclosure.

FIGS. 4A and 4B are diagrams that illustrates an exemplary processing pipeline for hypergraph-based collaborative filtering recommendations, in accordance with an embodiment of the disclosure.

FIG. 5 is a diagram that illustrates an exemplary scenario of an architecture for hypergraph embeddings, in accordance with an embodiment of the disclosure.

FIG. 6 is a diagram that illustrates an exemplary scenario of contrastive learning, in accordance with an embodiment of the disclosure.

FIG. 7 is a diagram that illustrates an exemplary scenario for recommending a set of items to a set of users, in accordance with an embodiment of the disclosure.

FIG. 8 is a flowchart that illustrates operations of an exemplary method for hypergraph-based collaborative filtering recommendations, in accordance with an embodiment of the disclosure.

### DETAILED DESCRIPTION

The following described implementation may be found in an electronic device and method for hypergraph-based collaborative filtering recommendations. Exemplary aspects of the disclosure may provide an electronic device that may receive a collaborative filtering graph corresponding to a set of users and a set of items associated with the set of users. The collaborative filtering graph may correspond to user-item interaction data. Based on the received collaborative filtering graph, the electronic device may determine a first set of user embeddings and a first set of item embeddings. The electronic device may apply a semantic clustering model on each of the determined first set of user embeddings and the determined first set of item embeddings. Based on the application of the semantic clustering model, the electronic device may determine a second set of user embeddings and a second set of item embeddings. The electronic device may construct a hypergraph from the received collaborative filtering graph. The electronic device may determine a third set of user embeddings and a third set of item embeddings based on the constructed hypergraph. The electronic device may determine a first contrastive loss based on the determined second set of user embeddings and the determined third set of user embeddings. The electronic device may determine a second contrastive loss based on the determined second set of item embeddings and the determined third set of item embeddings. Further, the electronic device may determine a collaborative filtering score based on the determined first contrastive loss and the determined second contrastive loss. Thereafter, the electronic device may determine a recommendation of an item for a user based on the determined collaborative filtering score. The electronic device may render the determined recommended item on a display device.

Typically, a recommendation system may recommend items, associated with a domain, based on one or more parameters such as personal particulars (for example, age, gender, demographic information, and so on) associated with a target user, item consumption history, item consumption pattern, similarity between items to be recommended and items consumed by the target user, and so on. In some other typical recommendation systems, user embeddings may be generated based on features extracted from the one or more parameters. The recommendation system may generate embeddings associated with items (for example, movies) based on features (for example, a genre, a length, a cast, a studio, and so on) of a domain. The recommendation system may compare the embeddings of the items in the item consumption history of the target user and the items of the domain. The recommendation system may recommend items of the domain associated with embeddings that are similar to the embeddings of the items in the item consumption history.

Furthermore, in some conventional recommendation systems for content recommendation on OTT platforms or streaming services, regular bipartite graphs may be provided as an input. Such bipartite graphs may include a set of edges that may connect pairs of nodes. Further, the bipartite graphs may provide only inter-domain correlations (for example, user-to-item correlations). Intra-domain similarities (for example, user-to-user correlations or item-to item-correlations) may be learnt by the conventional recommendation system simultaneously. Generalization of such intra-domain similarities may be challenging. Moreover, data associated with the intra-domain similarities may be sparse as most users may not interact with all items of the set of items. Thus, a distribution of edge types may highly imbalanced. Hence, the recommendation system may be sub-optimal.

In order to address the aforesaid issues, the disclosed electronic device may employ hypergraph-based collaborative filtering framework for recommendations of items. Herein, the electronic device may apply the semantic clustering model on each of the determined first set of user embeddings and the determined first set of item embeddings to determine the second set of user embeddings and the second set of item embeddings. The electronic device may obtain positive and negative samples based on the application of the semantic clustering model. Further, the electronic device may construct the hypergraph from the received collaborative filtering graph. The constructed hypergraph may be used to explore higher-order relations between the set of users and the set of items. Further, the electronic device may determine the third set of user embeddings and the third set of item embeddings based on the constructed hypergraph. The determined third set of user embeddings and the determined third set of item embeddings may include features associated with latent relationships between the set of the users and the set of items as captured in the constructed hypergraph. The electronic device may employ a contrastive framework and determine the first contrastive loss and the second contrastive loss to determine recommendations. In some embodiments, the electronic device may determine final user embeddings and final item embeddings that may consider higher order relations as captured in the constructed hypergraph such that nonstructural but similar nodes (for example, set of users and set of items) may be placed closer and dissimilar nodes may be placed further apart. The final user embedding, and the final item embedding may maintain a balance between higher-order views and collaborative views of interaction data inferred from the collaborative filtering graph. The balance between final user embedding and the final item embedding may help to achieve optimum results in downstream tasks like recommendation systems, user clustering, community clustering, classification tasks etc.

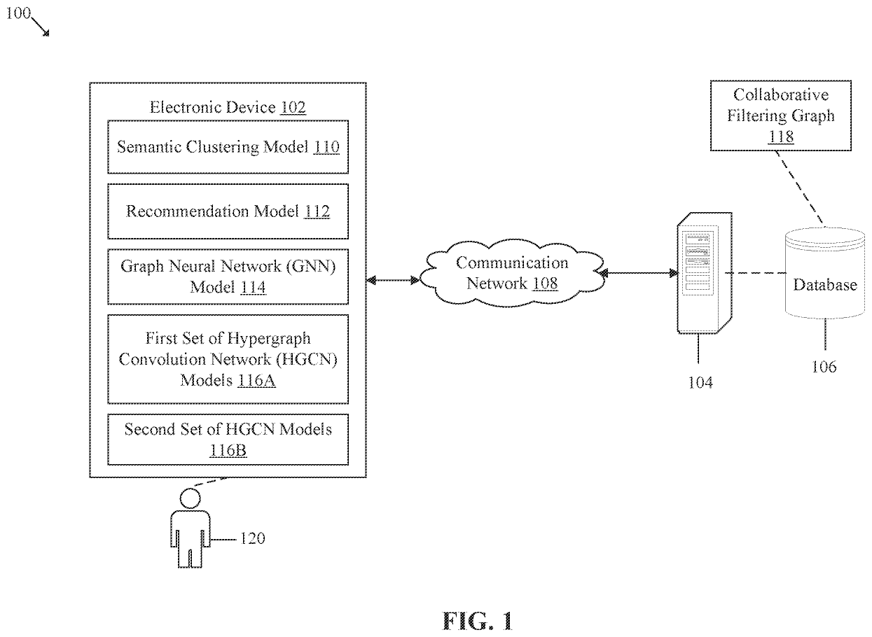

FIG. 1 is a block diagram that illustrates an exemplary network environment for hypergraph-based collaborative filtering recommendations, in accordance with an embodiment of the disclosure. With reference to FIG. 1, there is shown a network environment 100. The network environment 100 may include an electronic device 102, a server 104, a database 106, and a communication network 108. The electronic device 102 may include a semantic clustering model 110, a recommendation model 112, a graph neural network (GNN) model 114, a first set of hypergraph convolution network (HGCN) models 116A, and a second set of HGCN models 116B. In FIG. 1, there is further shown a collaborative filtering graph 118 that may be stored in the database 106. There is further shown a user 120, who may be associated with or may operate the electronic device 102.

The electronic device 102 may include suitable logic, circuitry, interfaces, and/or code that may be configured to receive the collaborative filtering graph 118 corresponding to a set of users and a set of items associated with the set of users. The electronic device 102 may receive the collaborative filtering graph 118 from the database 106 (which may store the collaborative filtering graph 118), via the server 104. Based on the received collaborative filtering graph 118, the electronic device 102 may determine a first set of user embeddings and a first set of item embeddings. The electronic device 102 may apply the semantic clustering model 110 on each of the determined first set of user embeddings and the determined first set of item embeddings. Based on the application of the semantic clustering model 110, the electronic device 102 may determine a second set of user embeddings and a second set of item embeddings. The electronic device 102 may construct a hypergraph from the received collaborative filtering graph 118. The electronic device 102 may determine a third set of user embeddings and a third set of item embeddings based on the constructed hypergraph. The electronic device 102 may determine a first contrastive loss based on the determined second set of user embeddings and the determined third set of user embeddings. The electronic device 102 may determine a second contrastive loss based on the determined second set of item embeddings and the determined third set of item embeddings. For example, the electronic device 102 may determine the first contrastive loss based on the determined first set of user embeddings with spectral similarity and local collaborative graph and second set of user embeddings from the hypergraph and the determined third set of user embeddings. The electronic device 102 may determine the second contrastive loss based on the determined first set of item embeddings from semantic similarity grouped local collaborative graph and the determined second set of item embeddings from the hypergraph. Further, the electronic device 102 may determine a collaborative filtering score based on the determined first contrastive loss and the determined second contrastive loss. Thereafter, the electronic device 102 may determine a recommendation of an item for a user (for example, the user 120) based on the determined collaborative filtering score. The electronic device 102 may render the determined recommended item on a display device.

Examples of the electronic device 102 may include, but are not limited to, a computing device, a smartphone, a cellular phone, a mobile phone, a gaming device, a mainframe machine, a server, a computer workstation, a machine learning device (enabled with or hosting, for example, a computing resource, a memory resource, and a networking resource), and/or a consumer electronic (CE) device.

The server 104 may include suitable logic, circuitry, and interfaces, and/or code that may be configured to receive, from the database 106, the collaborative filtering graph 118 corresponding to the set of users and the set of items associated with the set of users. The server 104 may determine the first set of user embeddings and the first set of item embeddings based on the received collaborative filtering graph 118. The server 104 may apply the semantic clustering model 110 on each of the determined first set of user embeddings and the determined first set of item embeddings. The server 104 may determine the second set of user embeddings and the second set of item embeddings based on the application of the semantic clustering model 110. The server 104 may construct the hypergraph from the received collaborative filtering graph 118. The server 104 may determine the third set of user embeddings and the third set of item embeddings based on the constructed hypergraph. The server 104 may determine the first contrastive loss based on the determined second set of user embeddings and the determined third set of user embeddings. The server 104 may determine the second contrastive loss based on the determined second set of item embeddings and the determined third set of item embeddings. The server 104 may determine the collaborative filtering score based on the determined first contrastive loss and the determined second contrastive loss. The server 104 may determine the recommendation of the item for the user, for example the user 120, based on the determined collaborative filtering score. The server 104 may render the determined recommended item on the display device.

The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the collaborative filtering graph 118. The database 106 may also store information associated with set of users and the set of items. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for the collaborative filtering graph 118 from the electronic device 102 or the server 104. In response, the device of the database 106 may be configured to retrieve and provide the queried collaborative filtering graph 118 to the electronic device 102 or the server 104, based on the received query.

In some embodiments, the database 106 may be hosted on a plurality of servers stored at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102 and the server 104 may communicate with one another. The communication network 108 may be one of a wired connection or a wireless connection. Examples of the communication network 108 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The semantic clustering model 110 may be a machine learning (ML) model that may cluster an input dataset into a set of clusters. Herein, each cluster may include a subset of similar datasets. The semantic clustering model 110 of the present disclosure may be applied to each of the determined first set of user embeddings and the determined first set of item embeddings. The semantic clustering model 110 may determine the second set of user embeddings and the second set of item embeddings from the determined first set of user embeddings and the determined first set of item embeddings, respectively. In an embodiment, the semantic clustering model 110 may correspond to a spectral clustering model configured for dimensionality reduction. That is, herein dimensions of the determined second set of user embeddings and the determined second set of item embeddings (as determined based on the application of the semantic clustering model 110) may be smaller than the dimensions of the determined first set of user embeddings and the dimensions of the determined first set of item embeddings, respectively.

The recommendation model 112 may be an ML model that may determine recommendations based on various criteria. For example, the recommendation model 112 may recommend one or more products to a customer based on, a purchase history of the customer, a geographical location of the customer, a need of the customer, and the like. The recommendation model 112 of the present disclosure may determine the recommendation of the item for the user 120 based on the determined collaborative filtering score.

The GNN model 114 may a deep learning model that may construct a graph based on a received dataset. Thereafter, the GNN model 114 may process the constructed graph and may make deductions based on the constructed graph. The GNN model 114 of the present disclosure may be applied on the received collaborative filtering graph 118. The GNN model 114 may process the applied collaborative filtering graph 118 to determine each of the first set of user embeddings and the first set of item embeddings.

The first set of HGCN models 116A may be ML models that may process information associated with a hypergraph and may determine an inference based on the processing. The first set of HGCN models 116A may be applied on a fourth set of user embeddings. Herein, the fourth set of user embeddings may be determined based on a set of user-to-item correlations and a set of user-to-user correlations, wherein the correlations may be determined based on the constructed hypergraph. The first set of HGCN models 116A may determine the third set of user embeddings based on the determined fourth set of user embeddings. The second set of HGCN models 1168 may be applied on a fourth set of item embeddings. Herein, the fourth set of item embeddings may be determined based on a set of item-to-user correlations, wherein the correlations may be determined based on the constructed hypergraph. The second set of HGCN models 116B may determine the third set of item embeddings based on the determined fourth set of item embeddings.

The GNN model 114, the first set of HGCN models 116A, and the second set of HGCN models 116B may be graphic neural network (GNN) models. The GNN models may include suitable logic, circuitry, interfaces, and/or code that may configured to classify or analyze input graph data to generate an output result for a particular real-time application. For example, a trained GNN model such as, the GNN model 114 may recognize different nodes in the input graph data, and edges between each node in the input graph data. The edges may correspond to different connections or relationship between each node in the input graph data. Based on the recognized nodes and edges, the trained GNN model 114 may classify different nodes within the input graph data, into different labels or classes. In an example, a particular node of the input graph data may include a set of features associated therewith. The set of features may include, but are not limited to, a media content type, a length of a media content, a genre of the media content, a geographical location of the user 120, and so on. Further, each edge may connect with different nodes having similar set of features. The electronic device 102 may be configured to encode the set of features to generate a feature vector using the GNN models. After the encoding, information may be passed between the particular node and the neighboring nodes connected through the edges. Based on the information passed to the neighboring nodes, a final vector may be generated for each node. Such final vector may include information associated with the set of features for the particular node as well as the neighboring nodes, thereby providing reliable and accurate information associated with the particular node. As a result, the GNN models may analyze the information represented as the input graph data. The GNN models may be implemented using hardware including a processor, a microprocessor (e.g., to perform or control performance of one or more operations), a field-programmable gate array (FPGA), or an application-specific integrated circuit (ASIC). In some other instances, the GNN models may be a code, a program, or set of software instruction. The GNN models may be implemented using a combination of hardware and software.

In some embodiments, the GNN models may correspond to multiple classification layers for classification of different nodes in the input graph data, where each successive layer may use an output of a previous layer as input. Each classification layer may be associated with a plurality of edges, each of which may be further associated with plurality of weights. During training, the GNN models may be configured to filter or remove the edges or the nodes based on the input graph data and further provide an output result (i.e. a graph representation) of the GNN models. Examples of the GNN models may include, but are not limited to, a graph convolution network (GCN), a hyper graph convolution network (HGCN), a graph spatial-temporal networks with GCN, a recurrent neural network (RNN), a deep Bayesian neural network, and/or a combination of such networks.

In an embodiment, the semantic clustering model 110, the recommendation model 112, the GNN model 114, the first set of HGCN models 116A, and the second set of HGCN models 116B may be machine learning (ML) models. Each ML model may be trained to identify a relationship between inputs, such as features in a training dataset and output labels. Each ML model may be defined by its hyper-parameters, for example, number of weights, cost function, input size, number of layers, and the like. The parameters of each ML model may be tuned, and weights may be updated so as to move towards a global minimum of a cost function for the corresponding ML model. After several epochs of the training on the feature information in the training dataset, each ML model may be trained to output a recommendation, a prediction, information associated with a set of clusters, or a classification result for a set of inputs. For example, the ML model associated with the recommendation model 112 may recommend an item for the user 120.

Each ML model may include electronic data, which may be implemented as, for example, a software component of an application executable on the electronic device 102. Each ML model may rely on libraries, external scripts, or other logic/instructions for execution by a processing device. Each ML model may include code and routines configured to enable a computing device such as, the electronic device 102 to perform one or more operations such as, determining the recommendation. Additionally or alternatively, each ML model may be implemented using hardware including a processor, a microprocessor, a field-programmable gate array (FPGA), or an application-specific integrated circuit (ASIC). Alternatively, in some embodiments, the ML model may be implemented using a combination of hardware and software.

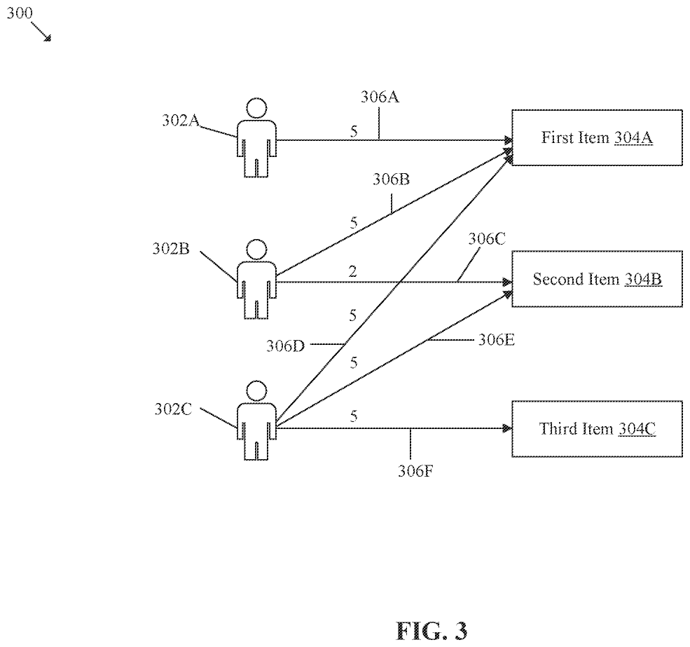

The collaborative filtering graph 118 may provide compact representations of interactions between the set of users and the set of items. The set of users and the set of items may be represented by a set of user nodes and a set of item nodes, respectively. Each edge of the collaborative filtering graph 118 may provide an interaction between a pair of nodes. Thus, the collaborative filtering graph 118 may be a bi-partite graph. Details related to the collaborative filtering graph 118 are further provided in FIG. 3.

In operation, the electronic device 102 may receive the collaborative filtering graph 118 corresponding to the set of users and the set of items associated with the set of users. For example, the database 106 may store the collaborative filtering graph 118. The electronic device 102 may request the database 106 for the collaborative filtering graph 118 and may receive the requested collaborative filtering graph 118 from the database 106, via the server 104. The collaborative filtering graph 118 may be the bipartite graph that may depict various interactions between the set of users and the set of items. The set of users and the set of items may be represented as nodes in the collaborative filtering graph 118. Each edge of the collaborative filtering graph 118 may depict an interaction between a pair of nodes of the collaborative filtering graph 118. For example, a user “A” may have bookmarked an item “B”. Therefore, the collaborative filtering graph 118 may include an edge between the user “A” and the item “B” depicting that the user “A” has bookmarked the item “B”. Details related to the collaborative filtering graph 118 are further described, for example, in FIG. 3.

The electronic device 102 may determine the first set of user embeddings and the first set of item embeddings based on the received collaborative filtering graph 118. It may be appreciated that an embedding may correspond to a vector representation of features associated with an entity. Each user embedding of the first set of user embeddings may provide features associated with a subset of items from the set of items that may have been watched or selected by the user associated with the corresponding user embedding. Each item embedding of the first set of item embeddings may correspond to features associated with a subset of users from the set of users that may have watched or selected the item associated with the corresponding item embedding.

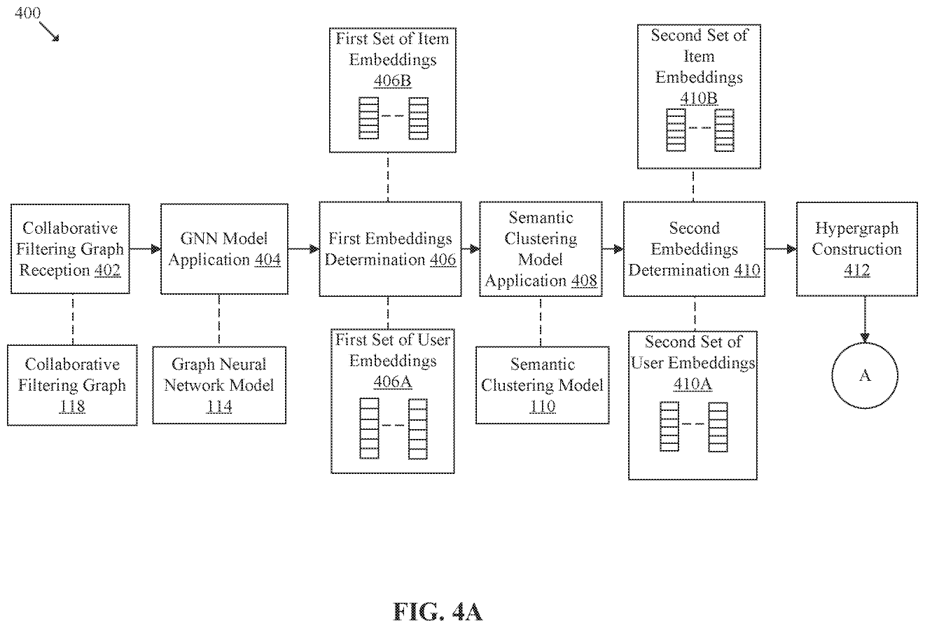

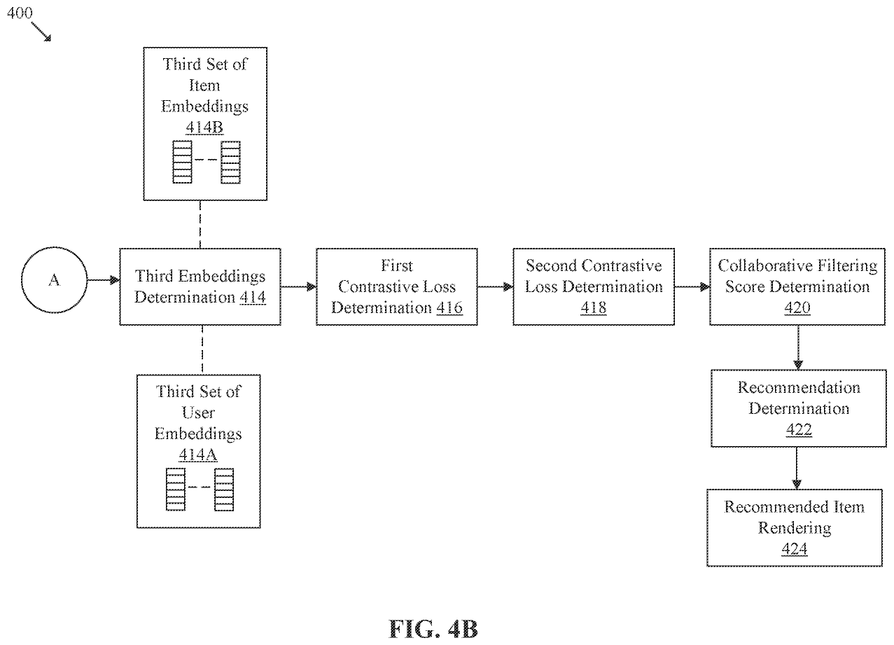

The collaborative filtering graph 118 may be used to generate the first set of user embeddings and the first set of item embeddings with multiple “k” hops in a neighborhood aggregation phase. Further, local collaborative signals may be a technique for addressing user-item interactions in a way that may make hypergraph signals appear as global signals. In an embodiment, the aforesaid process of generation of the first set of user embeddings and the first set of item embeddings with multiple “k” hops may be performed iteratively with odd number of hops and even number of hops respectively. For example, in a first hop, a user embedding associated with a user “U₁” may be represented by a vector of items “I₁”, “I₂”, and so on. In a third hop, further items may be added from the collaborative filtering graph 118 in the user embedding associated with the user “U₁”. Similarly, for even number of hops, each item may be associated with multiple users (the users that may have had some sort of interaction with the item in question). Therefore, a first hop aggregation may include the user “U₁” represented as a vector in terms of directly connected items such as, “I₁”, “I₂”, and so on. A second hop may help in representing items as vectors in term of users that may be directly or indirectly connected to the item. For example, the user “U₁” may be represented with an aggregation of items “I₁”, “I₂”, and so on that may be directly interacted with by the user “U₁” on the first hop. However, if the item “I₁” is also connected to a user “U₂” and the user “U₂” is connected to an item “I₅”, then there may be an indirect connection between the user “U₁” and item “I₅”. The aforesaid relationship may be aggregated on a third hop. Details related to the determination of the first set of user embeddings and the first set of item embeddings are further described, for example, in FIG. 4A.

The electronic device 102 may apply the semantic clustering model 110 on each of the determined first set of user embeddings and the determined first set of item embeddings. Based on an application of the semantic clustering model 110, a semantic view of the set of users and the set of items may be determined. A subset of users and a subset of items that may be directly connected to each other may be considered similar and may be grouped together to form a cluster. Details related to the application of the semantic clustering model are further described, for example, in FIG. 4A.

The electronic device 102 may determine the second set of user embeddings and the second set of item embeddings based on the application of the semantic clustering model 110. The second set of user embeddings and the second set of item embeddings may be extracted from the semantic view of the set of users and the set of items. Details related to the determination of the second set of user embeddings and the second set of item embeddings are further described, for example, in FIG. 4A.

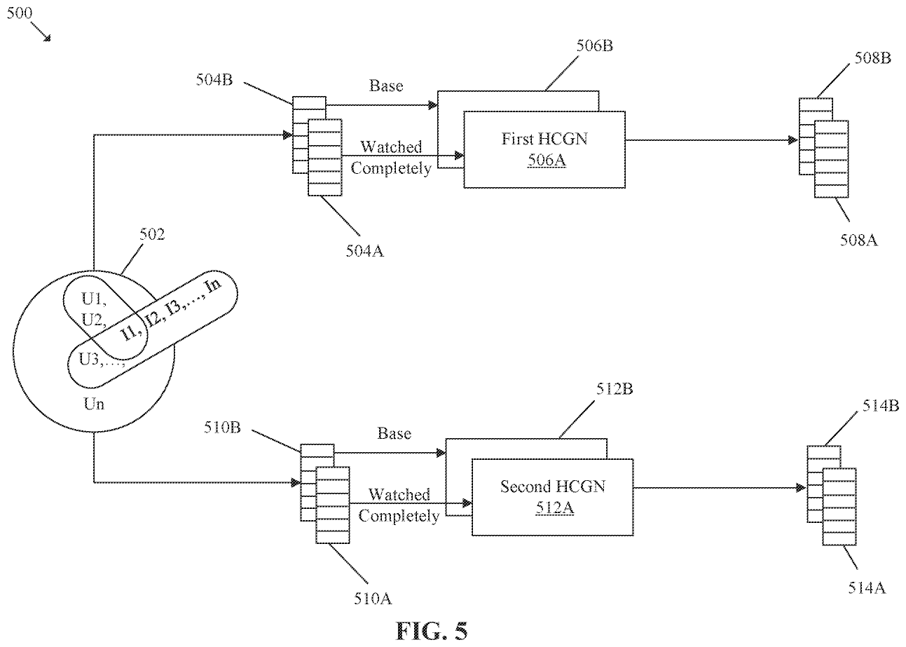

The electronic device 102 may construct the hypergraph from the received collaborative filtering graph 118. The hypergraph may be a graph that may represent higher-order relationships between the set of users and the set items associated with the collaborative filtering graph 118 by hyperedges. It should be noted that in OTT platforms, a user may not always be directly or indirectly connected to each other through an item node. The collaborative filtering graph may be prone to loss of information. In order to mitigate the aforesaid issue, the third set of user embeddings and the third set of item embeddings may be determined from the constructed hypergraph. Details related to the construction of the hypergraph are further described, for example, in FIG. 5.

The electronic device 102 may determine the third set of user embeddings and the third set of item embeddings based on the constructed hypergraph. The third set of user embeddings and the third set of item embeddings, so determined, may include information associated with higher-order relationships between the set of users and the set items. Further, the third set of user embeddings and the third set of item embeddings may also include features associated with latent relationships between the set of the users and the set of items, as captured in the constructed hypergraph. Details related to the determination of the third set of user embeddings and the third set of item embeddings are further provided in, for example, FIG. 5.

The electronic device 102 may determine the first contrastive loss based on the determined second set of user embeddings and the determined third set of user embeddings. The first contrastive loss may be a variation of a nearest-neighbor contrastive learning of visual representation (NNCLR) that may be determined based on the determined second set of user embeddings and the determined third set of user embeddings. Details related to the determination of the first contrastive loss are further described, for example, in FIG. 4B.

The electronic device 102 may determine the second contrastive loss based on the determined second set of item embeddings and the determined third set of item embeddings. The second contrastive loss may be a variation of the NNCLR that may be determined based on the determined second set of item embeddings and the determined third set of item embeddings. Details related to the determination of the second contrastive loss are further described, for example, in FIG. 4B.

The electronic device 102 may determine the collaborative filtering score based on the determined first contrastive loss and the determined second contrastive loss. The collaborative filtering score may provide a set of scores to the set of items for each user for the set of users. The set of scores may be used as a basis for determination of the recommendations for the set of users. Details related to the determination of the collaborative filtering score are further described, for example, in FIG. 4B.

The electronic device 102 may determine the recommendation of the item for the user 120 based on the determined collaborative filtering score. For each user, the item that may be associated with a highest score may be selected as the recommendation. For example, for the user 120, the set of scores may be “0.78”, “0.67”, and “0.82”. Thus, an item associated with the score of “0.82” may be determined as the recommendation for the user 120. Details related to the determination of the recommendation of the item are further described, for example, in FIG. 4B.

The electronic device 102 may render the determined recommended item on the display device. In an example, the determined recommend item may be an action movie that may be displayed on the display device as the recommendation. The user 120 may then select the action movie that may be thereafter played. Details related to the rendering of the determined recommended item further are described, for example, in FIG. 4B.

The electronic device 102 may employ contrastive learning with positive and negative pair formation from hypergraph embedding, GCN collaborative structural embedding, and spectral cluster-based semantic embedding. The use of the semantic clustering model 110 to form positive pairs with the third set of user embeddings and the third set of item embeddings may help to retain similarity information for better learning. The electronic device 102 may be used to make personalized recommendation on the over-the-top (OTT) platform, e-commerce platform, and the like. Herein, the electronic device 102 may further treat task of recommendation as a link prediction task or edge prediction task for each item of the set of items.

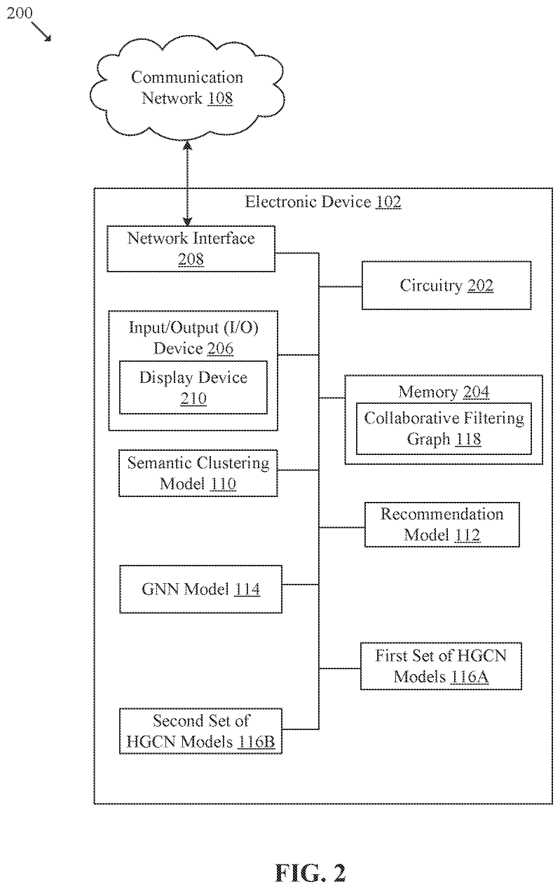

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, a network interface 208, the semantic clustering model 110, the recommendation model 112, the GNN model 114, the first set of HGCN models 116A, and the second set of HGCN models 1168. The memory 204 may store the collaborative filtering graph 118. The input/output (I/O) device 206 may include a display device 210.

The circuitry 202 may include suitable logic, circuitry, and/or interfaces that may be configured to execute program instructions associated with different operations to be executed by the electronic device 102. The operations may include a collaborative filtering graph reception, a GNN model application, first embeddings determination, a semantic clustering model application, second embeddings determination, a hypergraph construction, third embeddings determination, a first contrastive loss determination, a second contrastive loss determination, a collaborative filtering score determination, a recommendation determination, and a recommendation rendering. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be further configured to store the collaborative filtering graph 118. In an embodiment, the memory 204 may also store user embeddings and item embeddings. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a first user input indicative of a request for generation of a recommendation of an item for the user 120. The I/O device 206 may be further configured to display or render the recommended item. The I/O device 206 may include the display device 210. Examples of the I/O device 206 may include, but are not limited to, a display (e.g., a touch screen), a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102 and the server 104, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display or render the determined recommended item. The display device 210 may be a touch screen which may enable a user (e.g., the user 120) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for implementation of hypergraph-based collaborative filtering recommendations are described further, for example, in FIGS. 4A and 4B.

FIG. 3 is a diagram that illustrates an exemplary scenario of a collaborative filtering graph, in accordance with an embodiment of the disclosure. FIG. 3 is described in conjunction with elements from FIG. 1 and FIG. 2. With reference to FIG. 3, there is shown an exemplary scenario 300. The scenario 300 may include a set of users and a set of items. The set of users may include a first user 302A, a second user 302B, and a third user 302C. The set of items may include a first item 304A, a second item 304B, and a third item 304C. A set of operations associated with the scenario 300 is described herein.

In the scenario 300 of FIG. 3, the set of items such as, the first item 304A, the second item 304B, and the third item 304C may be different multi-media contents such as, sitcoms, news reports, digital games, and the like. Initially, the first user 302A, the second user 302B, and the third user 302C may be registered on the OTT platform. Each user of the set of users may watch one or more items of the set of items and may rate each of the watched one or more items on a scale of “1” to “5”. A rating of “1” may mean that the user may not at all like the rated item and a rating of “5” may mean that the user may highly like the rated item.

With reference to FIG. 3, the first user 302A may interact with the first item 304A and may provide a rating of “5” as illustrated by the edge 306A. The second user 302B may interact with the first item 304A and the second item 304B as depicted by the edge 306B and the edge 306C respectively. Further, the second user 302B may rate the first item 304A as “5” and the second item 304B as “2”. That is, the second user 302B may like the first item 304A more than the second item 304B. The third user 302C may interact with the first item 304A, the second item 304B, and the third item 304C as depicted by the edge 306D, the edge 306E, and the edge 306F respectively. Further, the third user 302C may rate the first item 304A, the second item 304B, and the third item 304C, as “5”, “5”, and “5” respectively. That is, the third user 302C may like the first item 304A, the second item 304B, and the third item 304C equally.

It should be noted that scenario 300 of FIG. 3 is for exemplary purposes and should not be construed to limit the scope of the disclosure.

FIGS. 4A and 4B are diagrams that illustrates an exemplary processing pipeline for hypergraph-based collaborative filtering recommendations, in accordance with an embodiment of the disclosure. FIGS. 4A and 4B are explained in conjunction with elements from FIG. 1, FIG. 2, and FIG. 3. With reference to FIGS. 4A and 4B, there is shown an exemplary processing pipeline 400 that illustrates exemplary operations from 402 to 424 for implementation of hypergraph-based collaborative filtering recommendations. The exemplary operations 402 to 424 may be executed by any computing system, for example, by the electronic device 102 of FIG. 1 or by the circuitry 202 of FIG. 2. FIGS. 4A and 4B further includes the collaborative filtering graph 118, the GNN model 114, a first set of user embeddings 406A, a first set of item embeddings 406B, a second set of user embeddings 410A, a second set of item embeddings 410B, a third set of user embeddings 414A, and a third set of item embeddings 414B.

At 402, an operation of collaborative filtering graph reception may be executed. The circuitry 202 may be configured to receive the collaborative filtering graph 118 corresponding to the set of users and the set of items associated with the set of users. Herein, the set of items may include different multi-media contents such as, sitcoms, news reports, digital games, and the like that may be associated with the set of users. The set of items may also include various items such as, garments, electronic appliances, gaming devices, books, and the like that may be sold on e-commerce applications or websites. It may be appreciated that different types of interactions between the set of users (such as, the first user 302A, the second user 302B, and the third user 302C of FIG. 3) and the set of items (such as, the, the first item 304A, the second item 304B, and the third item 304C of FIG. 3) may exist. For example, the different types of the interactions may be, selecting an item, adding the item to a digital cart, wish-listing the item on the e-commerce app, watching a video, bookmarking a video, or liking a video, or rating a video on the OTT platform. Interactions between the set of users and the set of items may be represented as a graph called a bipartite graph, in case only one type of interaction may exist between the set of users and the set of items. However, as the interactions between the set of users and the set of items may be of different types, thus, the graph so formed may be heterogeneous in nature and may form a multiplex bipartite graph. The collaborative filtering graph 118 may be the bipartite graph or the multiplex bipartite graph formed based on the interactions between the set of users and the set of items. Details related to the collaborative filtering graph are further provided, for example, in FIG. 3.

At 404, an operation of application of the GNN model 114 on the received collaborative filtering graph 118 may be executed. The circuitry 202 may be configured to apply the GNN model 114 on the received collaborative filtering graph 118. The GNN model 114 may process the received collaborative filtering graph 118 to derive information associated with each user and each item. In an embodiment, the GNN model 114 may be a graph convolutional network (GCN) model.

At 406, an operation of determination of the first set of user embeddings 406A and the first set of item embeddings 406B may be executed. The circuitry 202 may be configured to determine the first set of user embeddings 406A and the first set of item embeddings 406B. Herein, each of the first set of user embeddings 406A and the first set of item embeddings 406B may be determined based on the application of the GNN model 114. An embedding may correspond to a vector representation of features associated with an entity. For example, each of the first set of user embeddings 406A may correspond to features associated with a subset of items from the set of items that may have been watched or selected by the corresponding user. Each item embedding of the first set of item embeddings 406B may correspond to features associated with a subset of users from the set of users that may have watched or selected the subset of users.

With reference to FIG. 3, the third user 302C may have rated the first item 304A, the second item 304B, and the third item 304C as “5”, “5”, and “5”, respectively. Therefore, a user embedding for the third user 302C may include identification numbers of items that the third user 302C may have rated as “5”. That is, the user embedding for the third user 302C may include identification numbers of the first item 304A, the second item 304B, and the third item 304C. Further, the user embedding for the third user 302C may include identification numbers of item types, genres, video lengths, languages, and the like, associated with the first item 304A, the second item 304B, and the third item 304C. Similarly, the user embeddings associated with the first user 302A and the second user 302B may be determined for each rating provided by each of the first user 302A and the second user 302B. Further, with reference to FIG. 3, it may be observed that the third item 304C may have been rated “5” by only the third user 302C. Thus, the item embedding for the third item 304C may include information such as, a name, an identification, a geographical location, and the like, of the third user 302C. Similarly, the item embeddings associated with the first item 304A and the second item 304B may be determined for each rating as provided by each of the first user 302A, the second user 302B, and the third user 302C. The first set of user embeddings 406A and the first set of item embeddings 406B may be thus determined.

Referring back to FIG. 4, at 408, an operation of the semantic clustering model application may be executed. The circuitry 202 may be configured to apply the semantic clustering model 110 on each of the determined first set of user embeddings 406A and the determined first set of item embeddings 406B.

In an embodiment, the semantic clustering model 110 may correspond to a spectral-clustering model configured for dimensionality reduction of each of the first set of user embeddings 406A and the first set of item embeddings 406B. It may be appreciated that the spectral clustering model may be a clustering mechanism that may make use of spectrum such as, eigen values of a similarity matrix of an input dataset, to perform dimensionality reduction of the input dataset before clustering the input dataset in fewer dimensions. The input dataset for the present disclosure may include each of the first set of user embeddings 406A and the first set of item embeddings 406B.

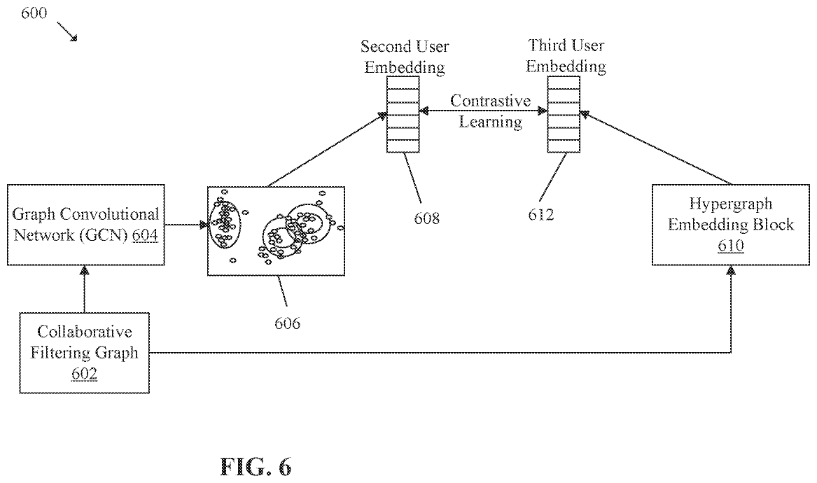

A spectral clustering algorithm associated with the spectral clustering model may project the input dataset into an “ [symbol] ⁿ” matrix that may be needed to be clustered into “k” clusters. A Gaussian kernel matrix “K” or an adjacency matrix “A” may be created to construct an affinity matrix based on the projected input dataset. It may be appreciated that a Gaussian kernel function may be used to measure a similarity in the spectral clustering algorithm. The adjacency matrix “A” may be a representation of the projected input dataset such that a set of rows associated with the adjacency matrix “A” may represent the first set of users and a set of columns associated with the adjacency matrix “A” may represent the first set of items. Each entry in the adjacency matrix “A” may provide information of an interaction between a user and an item. In an example, an entry in a first row and a first column of the adjacency matrix “A” may be “1”. Therefore, a first user associated with the first row may have watched or selected a first item associated with the first column of the adjacency matrix “A”. Further, in an example, an entry in a first row and a second column of the adjacency matrix “A” may be “0”. Therefore, a first user associated with the first row may not have watched or selected a second item associated with the second column of the adjacency matrix “A”. Based on the created Gaussian kernel matrix “K” or the adjacency matrix “A”, the affinity matrix may be constructed. The affinity matrix may be also called a similarity matrix and may be provide information associated with how similar a pair of entities may to each other. If an entry associated with the pair of entities is “0” in the affinity matrix then the corresponding pair of entities may be dissimilar. If an entry associated with the pair of entities is “1” then the corresponding pair of entities may be similar. In other words, each entry of the affinity matrix may correspond to a weight of an edge associated with the pair of entities. Based on the constructed the affinity matrix, a graph Laplacian matrix “L” may be created. It may be appreciated the graph Laplacian matrix “L” may be obtained based on a difference of the adjacency matrix “A” from a degree Matrix. Upon determination of the graph Laplacian matrix “L”, an eigenvalue challenge may be fixed. An advantage of using the graph Laplacian matrix “L” is that how well the clusters are connected to each other may be determined based on the smallest Eigen values of the graph Laplacian matrix “L”. Low values may mean the clusters are weakly connected which may be particularly useful as distinct clusters may have weak connections. A k-dimensional subspace may be established based on a selection of “k” eigenvectors that may correspond to “k” number of lowest (or highest) eigenvalues. Thereafter, clusters may be created in the k-dimensional subspace using a “k-means” clustering algorithm. Details related to the spectral clustering are further provided in, for example, FIG. 6.

At 410, an operation of the second embeddings determination may be executed. The circuitry 202 may be configured to determine the second set of user embeddings 410A and the second set of item embeddings 410B based on the application of the semantic clustering model 110. Based on the application of the semantic clustering model 110, a set of clusters may be determined. The second set of user embeddings 410A and the second set of item embeddings 410B may be extracted from the set of clusters. The determination of the second set of user embeddings and the second set of item embeddings is described further, for example, in FIG. 6.

At 412, an operation of the hypergraph construction may be executed. The circuitry 202 may be configured to construct the hypergraph from the received collaborative filtering graph 118. The hypergraph may be a graph that may represent higher-order relationships between the set of users and the set items associated with the collaborative filtering graph 118 by use of hyperedges. It may be appreciated that a regular edge in a graph may depict an interaction between a pair of nodes and may thus, ignore information between one node type and a latent representation of the node type with other node types. In an example, the received collaborative filtering graph 118 may depict that a user “A” may like a movie “X”. Such information may be captured in an embedding space using, for example, the first set of user embeddings 406A and the first set of item embeddings 406B. However, due to the nature of the received collaborative filtering graph 118 and sparsity in the information, the embedding space may not include information associated with other items that the user “A” may have not interacted. For example, the user “A” may have interacted with the movie “X” and may not have interacted with other movies. Therefore, a special type of edge that may connect multiple nodes in “n-dimensions”, called the hyperedge, may be used in the hypergraph. Details related to the hypergraph are further provided in, for example, FIG. 5.

At 414, an operation of third embeddings determination may be executed. The circuitry 202 may be configured to determine the third set of user embeddings 414A and the third set of item embeddings 414B based on the constructed hypergraph. Details related to the determination of the third set of user embeddings 414A and the third set of item embeddings 414B are further provided in, for example, FIG. 5.

At 416, an operation of first contrastive loss determination may be executed. The circuitry 202 may be configured to determine the first contrastive loss based on the determined second set of user embeddings 410A and the determined third set of user embeddings 414A. The first contrastive loss may be the variation of the NNCLR. Herein, a nearest neighbor operator may be replaced by a cluster of similar nodes of respective type and instead of an augmented view, a hypergraph embedding of a similar user may be used. The NNCLR may be obtained according to an equation (1):

$${ℒ}_{i}^{NNCLR} = - log ( \frac{exp ( {Z}_{{u}_{{i}^{* , j}}} \cdot \frac{{X}_{{u}_{i}}}{τ} )}{{\sum }_{k = 1}^{n} exp ( {Z}_{{u}_{{i}^{* , j}}} \cdot \frac{Z}{τ} )} ) , \qquad ( 1 )$$

where “τ” may be a SoftMax temperature,
“Xᵤ_{ᵢ}” may be a third user embedding associated with a user “i”, and
“Zᵤ_{_{i*}}_{,}_{ⱼ}” may be the second embedding of the user “i”'s most similar user “i*” from as obtained a cluster “j”.

At 418, an operation of second contrastive loss determination may be executed. The circuitry 202 may be configured to determine the second contrastive loss based on the determined second set of item embeddings 4108 and the determined third set of item embeddings 4148. The second contrastive loss may be similar to the first contrastive loss and may be determined according to an equation (2):

$${ℒ}_{i}^{NNCLR} = - log ( \frac{exp ( {Z}_{{u}_{{i}^{* , j}}} \cdot \frac{{X}_{{u}_{i}}}{τ} )}{{\sum }_{k = 1}^{n} exp ( {Z}_{{u}_{{i}^{* , j}}} \cdot \frac{Z}{τ} )} ) , \qquad ( 2 )$$

where “τ” may be the SoftMax temperature,
“Xᵤ_{ᵢ}” may be a third item embedding associated with an item “i”, and
“Zᵥ_{_{i*}}_{,j}” may be the second embedding of the item “i”'s most similar item “i*” as obtained from the cluster “j”.

At 420, an operation of collaborative filtering score determination may be executed. The circuitry 202 may be configured to determine the collaborative filtering score based on the determined first contrastive loss and the determined second contrastive loss. The collaborative filtering score may provide a set of scores to the set of items for each user for the set of users. The set of scores may be in accordance with likings, past interactions, and choices of the set of users.

In an embodiment, the circuitry 202 may be further configured to determine a fifth set of user embeddings based on the first contrastive loss and third set of user embeddings. The circuitry 202 may be further configured to determine a fifth set of item embeddings based on the second contrastive loss and third set of item embeddings. The fifth set of user embeddings may provide a vector representation of features associated with the set of users. The fifth set of item embeddings may provide a vector representation of features associated with the set of items.

In an embodiment, the circuitry 202 may be further configured to determine final user embeddings based on the determined fifth set of user embeddings. The circuitry 202 may be further configured to determine final item embeddings based on the determined fifth set of item embeddings. Herein, the determination of the collaborative filtering score may be further based on the determined final user embeddings and the determined final item embeddings.

In an example, the set of users may interact with the set of items by bookmarking items, by viewing items partially, and by viewing items completely. Thus, the determined fifth set of user embeddings may include a fifth user embedding associated with bookmarking of a subset of items from the set of items, a fifth user embedding associated with the partial viewing of a subset of items from the set of items, and a fifth user embedding associated with the complete viewing of a subset of items from the set of items for each user. Similarly, the determined fifth set of item embeddings may include for each item, a fifth item embedding associated with the bookmarking of the corresponding item by a subset of users from the set of users, a fifth user embedding associated with the partial viewing of the corresponding item by a subset of users from the set of users, and a fifth user embedding associated with the complete viewing of the corresponding item by a subset of users from the set of users. The final user embedding for a user such as, the user 120, may be determined based on a combination of the determined fifth user embeddings for the corresponding user. That is, the fifth user embedding associated with bookmarking, the fifth user embedding associated with the partial viewing, and the fifth user embedding associated with the complete viewing for a user such as, the user 120, may be combined to determine the final user embedding for the corresponding user. Similarly, the final item embedding for an item may be determined based on combination of the determined fifth item embeddings for the corresponding item. That is, the fifth item embedding associated with bookmarking, the fifth item embedding associated with the partial viewing, and the fifth item embedding associated with the complete viewing for the corresponding item may be combined to determine the final item embedding. In an embodiment, the final user embedding, and the final item embedding may be applied to a graph neural network (GNN) model or a natural language processing (NLP) model to generate recommendation probabilities for the set of items.

In an embodiment, each of the determined final user embeddings and the determined final item embeddings may correspond to a concatenation of at least one of a collaborative view, a hypergraph view, or a semantic view. It should be noted that the collaborative view for each of the determined final user embeddings and the determined final item embeddings may be associated with the first set of user embeddings 406A and the first set of item embeddings 406B, respectively. The hypergraph view may be also be termed as a higher-order view. The hypergraph view for each of the determined final user embeddings and the determined final item embeddings may be associated with the second set of user embeddings 410A and the second set of item embeddings 410B, respectively. The semantic view for each of the determined final user embeddings and the determined final item embeddings may be associated with the third set of user embeddings 414A and the third set of item embeddings 414B, respectively. The determined final user embeddings may be associated with the first set of user embeddings 406A, the second set of user embeddings 410A, and the third set of user embeddings 414A. Similarly, the determined final item embeddings may be associated with the first set of item embeddings 406B, the second set of item embeddings 410B, and the third set of item embeddings 414B. Thus, each of the determined final user embeddings and the determined final item embeddings may correspond to the concatenation of at least one of the collaborative view, the hypergraph view, or the semantic view.

At 422, an operation of recommendation determination may be executed. The circuitry 202 may be configured to determine the recommendation of the item for the user 120 based on the determined collaborative filtering score. In an embodiment, the collaborative filtering score may provide a set of scores to the set of items for each user for the set of users. For each user, an item that may be associated with a highest score may be selected as the recommendation. In an example, the set of users may include a user “A”, a user “B”, and a user “C” and the set of items may include an item “X”, an item “Y”, and an item “Z”. For the user “A”, the set of scores may include “0.1”, “0.5”, and “0.7 associated with the item “X”, the item “Y”, and the item “Z”, respectively. In such case, as the item “Z” has the highest score for the user “A”, the item “Z” may be determined as the recommendation for the user “A”.

At 424, an operation of rendering of the recommended item may be executed. The circuitry 202 may be configured to render the determined recommended item on the display device 210. In an example, the determined recommend item may be a movie “X”. The recommended movie “X” may be displayed on the display device 210 to notify the user 120 associated with the electronic device 102. The movie “X” may then be played based on a user input associated with a selection of the movie “X” from the user 120.

FIG. 5 is a diagram that illustrates an exemplary scenario of an architecture for hypergraph embeddings, in accordance with an embodiment of the disclosure. FIG. 5 is described in conjunction with elements from FIG. 1, FIG. 2, FIG. 3, FIG. 4A, and FIG. 4B. With reference to FIG. 5, there is shown an exemplary scenario 500. The scenario 500 may include a hypergraph 502, a fourth user embedding 504A, a fourth user embedding 504B, a first hypergraph convolution network (HGCN) model 506A, a first HGCN model 506B, a third user embedding 508A, a third user embedding 508B, a fourth item embedding 510A, a fourth item embedding 510B, a second HGCN model 512A, a second HGCN model 512B, a third item embedding 514A, and a third item embedding 514B. A set of operations associated with the scenario 500 is described herein.

In the scenario 500, the hypergraph 502 may be constructed based on the received collaborative filtering graph (for example, the collaborative filtering graph 118 of FIG. 4A). In an embodiment, the constructed hypergraph 502 may correspond to a multiplex bipartite graph with homogenous edges. The constructed hypergraph 502 may be the multiplex bipartite graph as the constructed hypergraph 502 may depict multiple types of interactions between the set of users and the set of items. Further, the constructed hypergraph 502 may be formed such that one hyperedge may depict one type of interaction.

In an embodiment, a first edge type in the hypergraph 502 may correspond to an interaction between a first user and a subset of first items associated with the first user. A second edge type in the hypergraph may correspond to an interaction between a subset of second users and a second item associated with each of the subset of second users. For example, a first hyperedge type may be formed to depict a subset of items that may be rated “1” by the first user. Another first hyperedge type may be formed to depict a subset of items that may be rated “2” by the first user. A second hyperedge type may be formed to depict a subset of users that may have rated the first item as “1”. Another second hyperedge type may be formed to depict a subset of users that may have rated the first item as “2”.

It should be noted that a homogeneous hypergraph constructed based on the first hyperedge types may be defined according to an equation (3):

Hypergraph=G(G_{U,base},GUᵢ₌₁ⁿi), where G_{U,i}={U,W_{U,i}},G_{U,base}∈G_{U} and G_{U,base}=G(U,Uᵢ₌₁^{k},E_{U,i}), (3)

where, “G_{U,base}” may be a homogeneous graph, “U” may be a user set, and “E_{U, i}” may be a set of first hyperedge types.

It should be noted that a homogenous hypergraph constructed based on the second hyperedge types may be defined according to an equation (4):

Hypergraph=G(G_{I,base},GIⱼ₌₁ⁿj),where G_{I,j}={I,E_{I,j}},G_{I,base}∈G_{I} and G_{I,base}=G(I,I_{j=I}^{k},E_{I,j}), (4)

where, “G_{U, base}” may the homogeneous graph, “I” is an item set, and “E_{I,j}” may be a set of second hyperedge types.

It should be noted that the hypergraph 502 may use an incidence matrix “H” for the user set “U”. The incidence matrix for the user set “U” may be defined according to an equation (5):

$${H}_{U} {,}_{i} ( u , e ) = \{ \begin{matrix}1 , if incident to e , e ∈ {E}_{U} {,}_{i} \\ 0 , if not\end{matrix} where {H}_{U} {,}_{i} ( u , e ) ∈ {ℝ}^{\vert U \vert * \vert {E}_{U} {,}_{i} \vert} and i ∈ \{ base , 1 , I , k \} \qquad ( 5 )$$

where “E_{U,i}” may be a set of first hyperedge types and “i” may denote a constructed hypergraph. Similarly, an incidence matrix for an item set “I” may be defined as “H_{I,j} (i, e)”

In an embodiment, the circuitry 202 may be further configured to determine a set of user-to-item correlations, a set of item-to-user correlations, and a set of user-to-user correlations based on the constructed hypergraph 502. The set of user-to-item correlations may be determined based on the first edge types and may depict relationships of users with items. For example, a first user-to-item correlation may provide information associated with a set of items that the first user may have watched completely. A second user-to-item correlation may provide information associated with a set of items that the first user may have selected as a base. The set of item-to-user correlations may be determined based on the second edge types and may provide information associated with relationships of items with users. For example, a first item-to-user correlation may depict a set of users that may have completely watched the first item. A second item-to-user correlation may provide information associated with a set of users that may have selected the first item as the base. The set of user-to-user correlations may be determined based on first edge types and the second edge types and may provide information associated with latent relationships of users with users. For example, a first user may watch a movie “X” completely. Similarly, a second user may also watch the movie “X” completely. Herein, a relationship may exist between the first user and the second user. A user-to-user correlation may be determined to capture the aforesaid relationship.

The circuitry 202 may be further configured to determine a fourth set of user embeddings (e.g., the fourth user embedding 504A) based on the determined set of user-to-item correlations and the set of user-to-user correlations. The fourth set of user embeddings may include one or more user embeddings for each user. Each of the one or more user embeddings associated with a user may correspond to one interaction type. For example, with reference to FIG. 5, a first interaction type may be associated with watching one or more items completely and a second interaction type may be associated with watching one or more items partially. The fourth user embedding 504A may be formed based on the user-to-item correlation and the set of user-to-user correlation corresponding to the first interaction type associated with a first user. The fourth user embedding 504B may be formed based on the user-to-item correlation and the set of user-to-user correlation corresponding to the second interaction type associated with the first user.

Upon determination of the fourth set of user embeddings, the circuitry 202 may be further configured to apply the first set of HGCN models (for example, the first set of HGCN models 116A of FIG. 1) on the determined fourth set of user embeddings (e.g., the fourth user embedding 504A). An HGCN model from the first set of HGCN models may be applied on each of the fourth set of user embeddings. The first set of HGCN models (for example, the first set of HGCN models 116A of FIG. 1) may be the ML models that may process information associated with the hypergraph 502 and may determine an inference based on the processing.

A convolutional operator associated with the first set of HGCN models (for example, the first set of HGCN models 116A of FIG. 1) for the constructed hypergraph 502 may be defined according to an equation (6):

X^{l+1}=σ(HWH^{T}·X^{l}·P^{l}) (6)

where “σ” may be a non-linear activation function, “X” may be a feature matrix, and “P” may be a learnable weight matrix. Further, “HWH^{T}” may be used to measure pairwise relationships between nodes in a same homogeneous hypergraph, where “W” may be a weight matrix that may assign weights to all hyperedges.

A normalised version of symmetric and asymmetric convolutional operators may be defined according to an equation (7) and (8):

$${X}_{U , i}^{l + 1} = σ ( {D}_{U , i}^{\frac{- 1}{2}} {H}_{U , i} {W}_{U} {B}_{U , i}^{- 1} {H}_{U , i}^{T} {D}_{U , i}^{\frac{- 1}{2}} . {X}_{U , i}^{l} . {P}_{U , i}^{l} ) and \qquad ( 7 )$$

$${X}_{U , i}^{l + 1} = σ ( {D}_{U , i}^{- 1} {H}_{U , i} {W}_{U} {B}_{U , i}^{- 1} {H}_{U , i}^{T} . {X}_{U , i}^{l} . {P}_{U , i}^{l} \qquad ( 8 )$$

With reference to the equation (7), “I” may be an identity matrix and “D” may be a node degree matrix of a simple graph. With reference to the equation (8), “σ” may be a non-linear activation function, “X_{U,i}^{l+1}”∈“R|U|×dl” may the feature of a layer “l”, “W_{U}”∈“R|V|×|V|” may be an identity matrix, and “P” may denote a learnable filter matrix, “Dₗ” and “Dₗ₊₁” may be dimensions of the layer “l” and a layer “l+1” respectively

For example, with reference to FIG. 5, the first HGCN model 506A may be applied on the fourth user embedding 504A and the first HGCN model 506B may be applied on the fourth user embedding 504B. Based on the application of the first set of HGCN models (for example, the first set of HGCN models 116A of FIG. 1), the third set of user embeddings may be determined. For example, with reference to FIG. 5, the third user embedding 508A for the first user may be determined based on the application of the first HGCN model 506A. The third user embedding 508B for the first user may be determined based on the application of the first HGCN model 506B. Similarly, the fourth user embedding for each user of the set of users may be determined for each interaction type.

The circuitry 202 may be further configured to determine a fourth set of item embeddings (e.g., the fourth item embedding 510A) based on the determined set of item-to-user correlations. The fourth set of item embeddings may include one or more item embeddings for each item. Each of the one or more item embeddings associated with an item may correspond to one interaction type. For example, with reference to FIG. 5, the fourth item embedding 510A may be formed based on the item-to-user correlation corresponding to the first interaction type associated with a first item. The fourth item embedding 510B may be formed based on the item-to-user correlation corresponding to the second interaction type associated with the first item.

Upon determination of the fourth set of item embeddings, the circuitry 202 may be further configured to apply the second set of HGCN models (for example, the second set of HGCN models 116B) on the determined fourth set of item embeddings. An HGCN model may be applied on each fourth item embedding. The second set of HGCN models (for example, the second set of HGCN models 116B of FIG. 1) may be the ML models that may process information associated with the hypergraph 502 and may determine an inference based on the processing. For example, with reference to FIG. 5, the second HGCN model 512A may be applied on the fourth item embedding 510A and the second HGCN model 512B may be applied on the fourth item embedding 510B. Based on the application of the second set of HGCN models (for example, the second set of HGCN models 116B of FIG. 1), the third set of item embeddings may be determined. For example, with reference to FIG. 5, the third item embedding 514A for the first item associated with watching the first item completely may be determined based on the application of the second HGCN model 512A. The third item embedding 514B for the first item associated with selecting the first item as the base may be determined based on the application of the second HGCN model 512B. Similarly, the fourth item embedding for each item of the set of items may be determined for each interaction type.

It should be noted that scenario 500 of FIG. 5 is for exemplary purposes and should not be construed to limit the scope of the disclosure.

FIG. 6 is a diagram that illustrates an exemplary scenario of contrastive learning, in accordance with an embodiment of the disclosure. FIG. 6 is described in conjunction with elements from FIG. 1, FIG. 2, FIG. 3, FIG. 4A, FIG. 4B, and FIG. 5. With reference to FIG. 6, there is shown an exemplary scenario 600. The scenario 600 may include a collaborative filtering graph 602, a graph convolutional network (GCN) 604, semantic clusters of user and item nodes 606, a second user embedding 608, a hypergraph embedding block 610, and a third user embedding 612. A set of operations associated the with scenario 600 is described herein. FIG. 6 has been explained with respect to contrastive learning for user embeddings. However, the scenario 600 of FIG. 6 may be similarly applicable to contrastive learning for item embeddings without departure from the scope of the disclosure.

It may be appreciated that self-supervision approaches that are usually used in a field of computer vision may involve a process of determination of the most discriminative representation of embeddings. In an example, discriminative representation of embeddings may be determined for a given set of different views of a same object in an image by augmentation. In another example, the discriminative representation of embeddings may be obtained by use of a similar object and a comparison of the object with other dissimilar objects. The aforesaid approach of the contrastive learning may be extended to recommendation systems. Herein, different augmentations of the user-item interactions may be used. The different augmentations may be obtained based on dropping of nodes, dropping of edges, replicating nodes, and the like. Augmented views of node embeddings in a mini-batch of interactions may form positive pairs and rest of the embeddings from the mini-batch may form negative pairs.

For example, with reference to FIG. 6, the GCN 604 may be applied on the collaborative filtering graph 602. The GCN 604 may be a generalized convolutional neural network that may employ semi-supervised based learning approaches on graphs. Based on the application of the GCN 604 on the collaborative filtering graph 602, the first set of user embeddings and the first set of item embeddings may be obtained. Further, the semantic clusters of user and item nodes 606 may be obtained based on the application of the GCN 604 on the collaborative filtering graph 602. Thereafter, based on the semantic clusters of users and item nodes 606, the second user embedding 608 may be obtained. The second user embedding 608 may be associated with similar users as determined from the semantic clusters of users and item nodes 606. Further, the collaborative filtering graph 602 may be applied to the hypergraph embedding block 610. The hypergraph embedding block 610 may include the first set of HGCN models (such as, the first HGCN model 506A and the first HGCN model 506B of FIG. 5) and the second set of HGCN models (such as, the second HGCN model 512A and the second HGCN model 512B of FIG. 5). The third user embedding 612 may be obtained based on the application of the collaborative filtering graph 602 to the hypergraph embedding block 610. The second user embedding 608 and the third user embedding 612 may be positive pairs of embeddings and may be used for contrastive learning purposes. Positive pairs of embeddings may be used for contrastive learning purposes. Further, negative samples may be those samples that may not be a part of a cluster that a user “U₁” belongs to.

It should be noted that scenario 600 of FIG. 6 is for exemplary purposes and should not be construed to limit the scope of the disclosure.

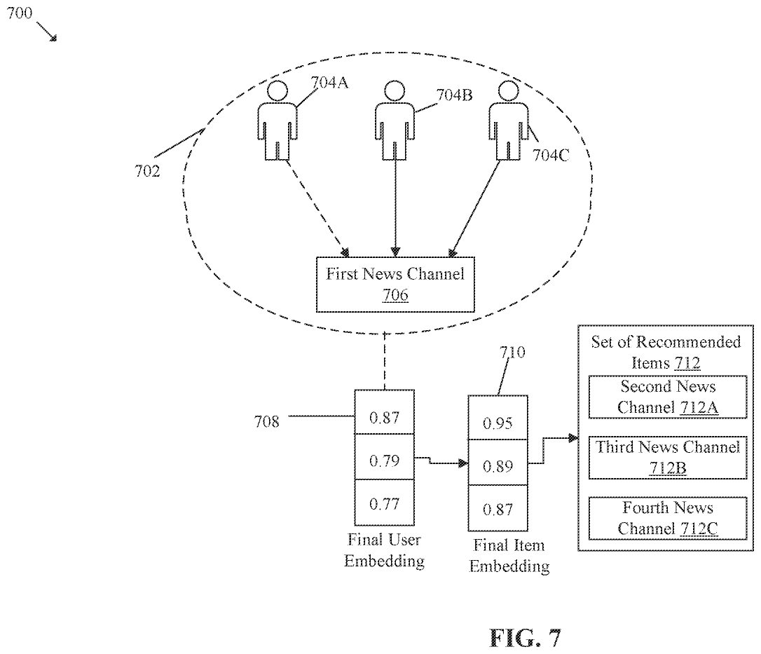

FIG. 7 is a diagram that illustrates an exemplary scenario for recommendation of a set of items to a set of users, in accordance with an embodiment of the disclosure. FIG. 7 is described in conjunction with elements from FIG. 1, FIG. 2, FIG. 3, FIG. 4A, FIG. 4B, FIG. 5, and FIG. 6. With reference to FIG. 7, there is shown an exemplary scenario 700. The scenario 700 may include a hyperedge 702, a first user 704A, a second user 704B, a third user 704C, a first news channel 706, a final user embedding 708, a final item embedding 710, and a set of recommended items 712. The set of recommended items 712 may include a second news channel 712A, a third news channel 712B, and a fourth news channel 712C. A set of operations associated with the scenario 700 is described herein.

In the scenario 700 of FIG. 7, the second user 704B and the third user 704C may have an active interest in the first news channel 706. For example, the second user 704B and the third user 704C may have watched the first news channel 706. The first user 704A may have not watched the first news channel 706. However, the first user 704A and the third user 704C may have also watched a news channel (not shown) similar to the first news channel 706. Thus, a latent relationship may exist between the first user 704A and the first news channel 706. Further, a latent relationship may exist between the first user 704A and the second user 704B. Therefore, the first user 704A, the second user 704B, and the third user 704C along with the first news channel 706 may form a hyperedge, such as, the hyperedge 702. Similar to the hyperedge 702, multiple hyperedges may be formed to construct the hypergraph. Based on the constructed hypergraph, the third set of user embeddings may be determined. The third set of user embeddings (not shown) may include a third user embedding associated with the first user 704A, a third user embedding associated with the second user 704B, and a third user embedding associated with the third user 704C. The third user embedding associated with the first user 704A, the third user embedding associated with the second user 704B, and the third user embedding associated with the third user 704C may be similar to each other. Based on the determined third set of user embeddings, the final user embedding 708 and the final item embedding 710 may be obtained. For example, as shown in FIG. 7, the final user embedding 708 may be “0.87”, “0.79”, and “0.77”, for the first user 704A, the second user 704B, and the third user 704C, respectively. The final user embedding 708 may correspond to a collaborative filtering score associated with the users 704A, 704B, and 704C. Further, the final item embedding 710 may be “0.95” for a first item, “0.89” for a second item, and “0.87” for a third item that may be recommended to the first user 704A, the second user 704B, and the third user 704C, respectively. The final item embedding 710 may correspond to a collaborative filtering score associated with the first item, the second item, and the third item. For example, based on the final user embedding 708 and the final item embedding 710, the second news channel 712A may be recommended to the first user 704A, the third news channel 712B may be recommended to the second user 704B, and the fourth news channel 712C may be recommended to the third user 704C. It should be noted that the second news channel 712A, the third news channel 712B, and the fourth news channel 712C may be similar to each other.

It should be noted that scenario 700 of FIG. 7 is for exemplary purposes and should not be construed to limit the scope of the disclosure.

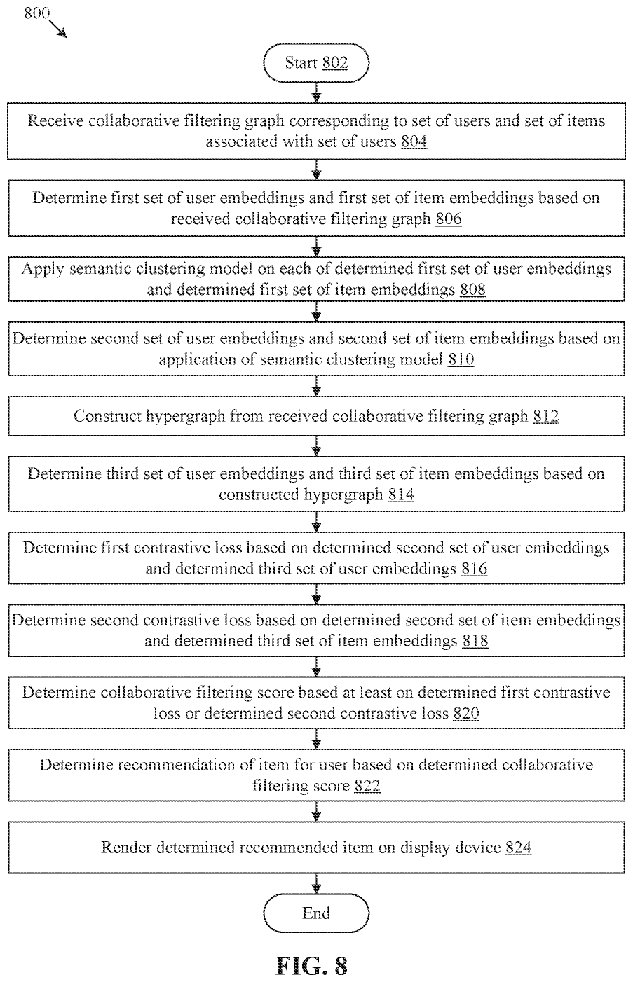

FIG. 8 is a flowchart that illustrates operations of an exemplary method for hypergraph-based collaborative filtering recommendations, in accordance with an embodiment of the disclosure. FIG. 8 is described in conjunction with elements from FIG. 1, FIG. 2, FIG. 3, FIG. 4A, FIG. 4B, FIG. 5, FIG. 6, and FIG. 7. With reference to FIG. 8, there is shown a flowchart 800. The flowchart 800 may include operations from 802 to 824 and may be implemented by the electronic device 102 of FIG. 1 or by the circuitry 202 of FIG. 2. The flowchart 800 may start at 802 and proceed to 804.

At 804, the collaborative filtering graph 118 corresponding to the set of users and the set of items associated with the set of users may be received. The circuitry 202 may be configured to receive the collaborative filtering graph 118 corresponding to the set of users and the set of items associated with the set of users. Details related to the collaborative filtering graph 118 are further described, for example, in FIG. 3.

At 806, the first set of user embeddings 406A and the first set of item embeddings 406B may be determined based on the received collaborative filtering graph 118. The circuitry 202 may be configured to determine the first set of user embeddings 406A and the first set of item embeddings 406B based on the received collaborative filtering graph 118. Details related to the first set of user embeddings 406A and the first set of item embeddings 406B are further described, for example, in FIG. 4A.

At 808, the semantic clustering model 110 may be applied on each of the determined first set of user embeddings 406A and the determined first set of item embeddings 406B. The circuitry 202 may be configured to apply the semantic clustering model 110 on each of the determined first set of user embeddings 406A and the determined first set of item embeddings 406B. Details related to the application of the semantic clustering model 110 are further described, for example, in FIG. 4A.

At 810, the second set of user embeddings 410A and the second set of item embeddings 4108 may be determined based on the application of the semantic clustering model 110. The circuitry 202 may be configured to determine the second set of user embeddings 410A and the second set of item embeddings 4108 based on the application of the semantic clustering model 110. Details related to the second set of user embeddings 410A and the second set of item embeddings 410B are further described, for example, in FIG. 4A.

At 812, the hypergraph (such as, the hypergraph 502 of FIG. 5) may be constructed from the received collaborative filtering graph 118. The circuitry 202 may be configured to construct the hypergraph (such as, the hypergraph 502 of FIG. 5) from the received collaborative filtering graph 118. Details related to the hypergraph 502 are further described, for example, in FIG. 5.

At 814, the third set of user embeddings 414A and the third set of item embeddings 4148 may be determined based on the constructed hypergraph. The circuitry 202 may be configured to determine the third set of user embeddings 414A and the third set of item embeddings 414B based on the constructed hypergraph. Details related to the third set of user embeddings 414A and the third set of item embeddings 414B are further described, for example, in FIG. 4B.

At 816, the first contrastive loss may be determined based on the determined second set of user embeddings 410A and the determined third set of user embeddings 414A. The circuitry 202 may be configured to determine the first contrastive loss based on the determined second set of user embeddings 410A and the determined third set of user embeddings 414A. Details related to the first contrastive loss is further described, for example, in FIG. 4B.

At 818, the second contrastive loss may be determined based on the determined second set of item embeddings 410B and the determined third set of item embeddings 414B. The circuitry 202 may be configured to determine the second contrastive loss based on the determined second set of item embeddings 410B and the determined third set of item embeddings 414B. Details related to the second contrastive loss is further described, for example, in FIG. 4B.

At 820, the collaborative filtering score may be determined based at least on the determined first contrastive loss and the determined second contrastive loss. The circuitry 202 may be configured to determine the collaborative filtering score based at least on the determined first contrastive loss and the determined second contrastive loss. Details related to the collaborative filtering score is further described, for example, in FIG. 4B.

At 822, the recommendation of the item for the user 120 may be determined based on the determined collaborative filtering score. The circuitry 202 may be configured to determine the recommendation of the item for the user 120 based on the determined collaborative filtering score. Details related to the recommendation of the item is further described, for example, in FIG. 4B.

At 824, the determined recommended item may be rendered on the display device 210. The circuitry 202 may be configured to render the determined recommended item on the display device 210. Details related to the rendering of the determined recommended item further described, for example, in FIG. 4B. Control may pass to end.

Although the flowchart 800 is illustrated as discrete operations, such as, 804, 806, 808, 810, 812, 814, 816, 818, 820, 822, and 824, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include receipt of a collaborative filtering graph (e.g., the collaborative filtering graph 118) corresponding to a set of users and a set of items associated with the set of users. The operations may further include determination of a first set of user embeddings (e.g., the first set of user embeddings 406A) and a first set of item embeddings (e.g., the first set of item embeddings 406B) based on the received collaborative filtering graph 118. The operations may further include application of a semantic clustering model (e.g., the semantic clustering model 110) on each of the determined first set of user embeddings 406A and the determined first set of item embeddings 406B. The operations may further include determination of a second set of user embeddings (e.g., the second set of user embeddings 410A) and a second set of item embeddings (e.g., the second set of item embeddings 410B) based on the application of the semantic clustering model 110. The operations may further include construction of the hypergraph (such as, the hypergraph 502 of FIG. 5) from the received collaborative filtering graph 118. The operations may further include determination of a third set of user embeddings (e.g., the third set of user embeddings 414A) and a third set of item embeddings (e.g., the third set of item embeddings 414B) based on the constructed hypergraph 502. The operations may further include determination of a first contrastive loss based on the determined second set of user embeddings 410A and the determined third set of user embeddings 414A. The operations may further include determination of a second contrastive loss based on the determined second set of item embeddings 410B and the determined third set of item embeddings 414B. The operations may further include determination of a collaborative filtering score based on the determined first contrastive loss and the determined second contrastive loss. The operations may further include determination of a recommendation of an item for a user, such as, the user 120, based on the determined collaborative filtering score. The operations may further include rendering of the determined recommended item on a display device (such as, the display device 210).

Exemplary aspects of the disclosure may provide an electronic device (such as, the electronic device 102 of FIG. 1) that includes circuitry (such as, the circuitry 202). The circuitry 202 may be configured to receive the collaborative filtering graph 118 corresponding to the set of users and the set of items associated with the set of users. The circuitry 202 may be configured to determine the first set of user embeddings 406A and the first set of item embeddings 406B based on the received collaborative filtering graph 118. The circuitry 202 may be configured to apply the semantic clustering model 110 on each of the determined first set of user embeddings 406A and the determined first set of item embeddings 406B. The circuitry 202 may be configured to determine the second set of user embeddings 410A and the second set of item embeddings 4108 based on the application of the semantic clustering model 110. The circuitry 202 may be configured to construct the hypergraph (such as, the hypergraph 502 of FIG. 5) from the received collaborative filtering graph 118. The circuitry 202 may be configured to determine the third set of user embeddings 414A and the third set of item embeddings 414B based on the constructed hypergraph. The circuitry 202 may be configured to determine the first contrastive loss based on the determined second set of user embeddings 410A and the determined third set of user embeddings 414A. The circuitry 202 may be configured to determine the second contrastive loss based on the determined second set of item embeddings 410B and the determined third set of item embeddings 414B. The circuitry 202 may be configured to determine the collaborative filtering score based on the determined first contrastive loss and the determined second contrastive loss. The circuitry 202 may be configured to determine the recommendation of the item for the user 120 based on the determined collaborative filtering score. The circuitry 202 may be configured to render the determined recommended item on the display device 210.

In an embodiment, the circuitry 202 may be further configured to apply a GNN model (e.g., the GNN model 114) on the received collaborative filtering graph 118, wherein each of the first set of user embeddings 406A and the first set of item embeddings 406B may be further determined based on the application of the GNN model 114.

In an embodiment, the circuitry 202 may be further configured to determine a set of user-to-item correlations, a set of item-to-user correlations, and a set of user-to-user correlations based on the constructed hypergraph 502. The circuitry 202 may be further configured to determine a fourth set of user embeddings based on the determined set of user-to-item correlations and the set of user-to-user correlations. The circuitry 202 may be further configured to apply a first set of HGCN models (e.g., the first set of HGCN models 116A) on the determined fourth set of user embeddings. The circuitry 202 may be further configured to determine the third set of user embeddings 414A based on the application of the first set of HGCN models 116A. The circuitry 202 may be further configured to determine a fourth set of item embeddings based on the determined set of item-to-user correlations. The circuitry 202 may be further configured to apply a second set of HGCN models (e.g., the second set of HGCN models 116B) on the determined fourth set of item embeddings. The circuitry 202 may be further configured to determine the third set of item embeddings 414B based on the application of the second set of HGCN models 1168.

In an embodiment, the semantic clustering model 110 may correspond to the spectral clustering model configured for dimensionality reduction.

In an embodiment, the circuitry 202 may be further configured to determine a fifth set of user embeddings based on the first contrastive loss and third set of user embeddings 414A. The circuitry 202 may be further configured to determine a fifth set of item embeddings based on the second contrastive loss and third set of item embeddings 414B.

In an embodiment, the circuitry 202 may be further configured to determine a final user embeddings based on the determined fifth set of user embeddings. The circuitry 202 may be further configured to determine a final item embeddings based on the determined fifth set of item embeddings, wherein the determination of the collaborative filtering score may further based on the determined final user embeddings and the determined final item embeddings.

In an embodiment, each of the determined final user embeddings and the determined final item embeddings may correspond to the concatenation of at least one of the collaborative view, the hypergraph view, or the semantic view.

In an embodiment, constructed hypergraph 502 may correspond to the multiplex bipartite graph with homogenous edges.

In an embodiment, a first edge type in the hypergraph 502 may correspond to an interaction between a first user and a subset of first items associated with the first user. a second edge type in the hypergraph 502 may correspond to an interaction between a subset of second users and a second item associated with each of the subset of second users.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive a collaborative filtering graph corresponding to a set of users and a set of items associated with the set of users;
determine a first set of user embeddings and a first set of item embeddings based on the received collaborative filtering graph;
apply a semantic clustering model on each of the determined first set of user embeddings and the determined first set of item embeddings;
determine a second set of user embeddings and a second set of item embeddings based on the application of the semantic clustering model;
construct a hypergraph from the received collaborative filtering graph;
determine a third set of user embeddings and a third set of item embeddings based on the constructed hypergraph;
determine a first contrastive loss based on the determined second set of user embeddings and the determined third set of user embeddings;
determine a second contrastive loss based on the determined second set of item embeddings and the determined third set of item embeddings;
determine a collaborative filtering score based on the determined first contrastive loss and the determined second contrastive loss;
determine a recommendation of an item for a user based on the determined collaborative filtering score; and
render the determined recommended item on a display device.

2. The electronic device according to claim 1, wherein the circuitry is further configured to:
apply a graph neural network model on the received collaborative filtering graph, wherein
each of the first set of user embeddings and the first set of item embeddings is further determined based on the application of the graph neural network model.

3. The electronic device according to claim 1, wherein the circuitry is further configured to:
determine a set of user-to-item correlations, a set of item-to-user correlations, and a set of user-to-user correlations based on the constructed hypergraph;
determine a fourth set of user embeddings based on the determined set of user-to-item correlations and the set of user-to-user correlations;
apply a first set of hypergraph convolution network (HGCN) models on the determined fourth set of user embeddings;
determine the third set of user embeddings based on the application of the first set of HGCN models;
determine a fourth set of item embeddings based on the determined set of item-to-user correlations;
apply a second set of HGCN models on the determined fourth set of item embeddings; and
determine the third set of item embeddings based on the application of the second set of HGCN models.

4. The electronic device according to claim 1, wherein the semantic clustering model corresponds to a spectral clustering model configured for dimensionality reduction.

5. The electronic device according to claim 1, wherein the circuitry is further configured to:
determine a fifth set of user embeddings based on the first contrastive loss and third set of user embeddings; and
determine a fifth set of item embeddings based on the second contrastive loss and third set of item embeddings.

6. The electronic device according to claim 5, wherein the circuitry is further configured to:
determine final user embeddings based on the determined fifth set of user embeddings; and
determine final item embeddings based on the determined fifth set of item embeddings, wherein
the determination of the collaborative filtering score is further based on the determined final user embeddings and the determined final item embeddings.

7. The electronic device according to claim 6, wherein each of the determined final user embeddings and the determined final item embeddings corresponds to a concatenation of at least one of a collaborative view, a hypergraph view, or a semantic view.

8. The electronic device according to claim 1, wherein the constructed hypergraph corresponds to a multiplex bipartite graph with homogenous edges.

9. The electronic device according to claim 1, wherein
a first edge type in the hypergraph corresponds to an interaction between a first user and a subset of first items associated with the first user, and
a second edge type in the hypergraph corresponds to an interaction between a subset of second users and a second item associated with each of the subset of second users.

10. A method, comprising:
in an electronic device:
receiving a collaborative filtering graph corresponding to a set of users and a set of items associated with the set of users;
determining a first set of user embeddings and a first set of item embeddings based on the received collaborative filtering graph;
applying a semantic clustering model on each of the determined first set of user embeddings and the determined first set of item embeddings;
determining a second set of user embeddings and a second set of item embeddings based on the application of the semantic clustering model;
constructing a hypergraph from the received collaborative filtering graph;
determining a third set of user embeddings and a third set of item embeddings based on the constructed hypergraph;
determining a first contrastive loss based on the determined second set of user embeddings and the determined third set of user embeddings;
determining a second contrastive loss based on the determined second set of item embeddings and the determined third set of item embeddings;
determining a collaborative filtering score based on the determined first contrastive loss and the determined second contrastive loss;
determining a recommendation of an item for a user based on the determined collaborative filtering score; and
rendering the determined recommended item on a display device.

11. The method according to claim 10, further comprising:
applying a graph neural network model on the received collaborative filtering graph, wherein
each of the first set of user embeddings and the first set of item embeddings is further determined based on the application of the graph neural network model.

12. The method according to claim 10, further comprising:
determining a set of user-to-item correlations, a set of item-to-user correlations, and a set of user-to-user correlations based on the constructed hypergraph;
determining a fourth set of user embeddings based on the determined set of user-to-item correlations and the set of user-to-user correlations;
applying a first set of hypergraph convolution network (HGCN) models on the determined fourth set of user embeddings;
determining the third set of user embeddings based on the application of the first set of HGCN models;
determining a fourth set of item embeddings based on the determined set of item-to-user correlations;
applying a second set of HGCN models on the determined fourth set of item embeddings; and
determining the third set of item embeddings based on the application of the second set of HGCN models.

13. The method according to claim 10, wherein the semantic clustering model corresponds to a spectral clustering model configured for dimensionality reduction.

14. The method according to claim 10, further comprising:
determining a fifth set of user embeddings based on the first contrastive loss and third set of user embeddings; and
determining a fifth set of item embeddings based on the second contrastive loss and third set of item embeddings.

15. The method according to claim 14, further comprising:
determining final user embeddings based on the determined fifth set of user embeddings; and
determining final item embeddings based on the determined fifth set of item embeddings, wherein
the determination of the collaborative filtering score is further based on the determined final user embeddings and the determined final item embeddings.

16. The method according to claim 15, wherein each of the determined final user embeddings and the determined final item embeddings corresponds to a concatenation of at least one of a collaborative view, a hypergraph view, or a semantic view.

17. The method according to claim 10, wherein the constructed hypergraph corresponds to a multiplex bipartite graph with homogenous edges.

18. The method according to claim 10, wherein
a first edge type in the hypergraph corresponds to an interaction between a first user and a subset of first items associated with the first user, and
a second edge type in the hypergraph corresponds to an interaction between a subset of second users and a second item associated with each of the subset of second users.

19. A non-transitory computer-readable medium having stored thereon, computer-executable instructions that when executed by an electronic device, causes the electronic device to execute operations, the operations comprising:
receiving a collaborative filtering graph corresponding to a set of users and a set of items associated with the set of users;
determining a first set of user embeddings and a first set of item embeddings based on the received collaborative filtering graph;
applying a semantic clustering model on each of the determined first set of user embeddings and the determined first set of item embeddings;
determining a second set of user embeddings and a second set of item embeddings based on the application of the semantic clustering model;
constructing a hypergraph from the received collaborative filtering graph;
determining a third set of user embeddings and a third set of item embeddings based on the constructed hypergraph;
determining a first contrastive loss based on the determined second set of user embeddings and the determined third set of user embeddings;
determining a second contrastive loss based on the determined second set of item embeddings and the determined third set of item embeddings;
determining a collaborative filtering score based on the determined first contrastive loss and the determined second contrastive loss;
determining a recommendation of an item for a user based on the determined collaborative filtering score; and
rendering the determined recommended item on a display device.

20. The non-transitory computer-readable medium according to claim 19, wherein the constructed hypergraph corresponds to a multiplex bipartite graph with homogenous edges.
